(19) United States
(12) Patent Application Publication
(10) Pub. No.: US 2006/0262714 A1
(43) Pub. Date: Nov. 23, 2006

(54) Method of reducing papr in multiple antenna ofdm communication system and multiple antenna ofdm communication system using the method

(76) Inventors: Vahid Tarokh, Belmont, MA (US); Jae-Hak Chung, Seoul (KR); Yung-Soo Kim, Gyeonggi-do (KR); Chan-Soo Hwang, Gyeonggi-do (KR)

Correspondence Address: DILWORTH & BARRESE, LLP, 333 EARLE OVINGTON BLVD., UNIONDALE, NY, 11553, US

(21) Appl. No.: 10/546,081

(22) PCT Filed: Feb. 13, 2004
(86) PCT No.: PCT/KR04/00295

§ 371 Date: Jun. 30, 2006

(30) Foreign Application Priority Data
Feb. 17, 2003 (KR) 10-2003-0009878

(51) Int. Cl. H04J 11/00; H04J 1/00

(52) U.S. Cl. 370/208; 370/480

(57) ABSTRACT

Provided is a method of reducing a peak-to-average-power ratio in a multiple antenna orthogonal frequency division multiplexing communication system. The method includes: reducing a peak-to-average-power ratio of input serial data sequences; space-time coding the input serial data sequences with the reduced peak-to-average-power ratio to generate N symbols to be tranmitted via N antennas; receiving the serial data sequences of the N symbols to transform the serial data sequences into N parallel data sequences; allocating each of the N parallel data sequences to Ns sub-carriers and performing Inverse Fast Fourier Transform on the N parallel data sequences; transforming the N parallel data sequences into N serial data symbols; and replicating a portion of the serial data symbols to generate cyclic prefixes and interleaving the cyclic prefixes into starting portions of the serial data symbols to cyclically expand the N symbols.

### TECHNICAL FIELD

The present invention relates to an orthogonal frequency division multiplexing communication system using multiple antennas.

### BACKGROUND ART

Multiple antennas are generally used to expand transmission capacity. Orthogonal frequency division multiplexing (OFDM) is a special form of multi-carrier transmission and is robust against frequency selective fading or narrowband interference. Thus, a receiver can easily overcome frequency selective fading or narrowband interference by is employing multiple antennas and OFDM. Therefore, multiple antennas and OFDM can contribute to the achievement of communication technology which is robust against channel environment and has large channel capacity. However, since OFDM has a relatively high peak-to-average power ratio (PAPR), power efficiency of a transmitter amplifier decreases with an increase in the PAPR. Accordingly, a high-priced transmitter amplifier with relatively high linearity is required to improve power efficiency.

FIG. 1 is a block diagram of a conventional single antenna OFDM communication system.

OFDM symbols are obtained by performing Inverse Fast Fourier Transform (IFFT) on symbols modulated by phase shift keying (PSK) or quadrature amplitude modulation (QAM).

When dᵢ is a complex QAM symbol, Nₛ is the number of sub-carriers, T is a symbol duration, and f_{c} is a frequency of the sub-carriers, a first OFDM symbol s(t) starting at time t=ts can be expressed as in Equation 1:

$$s ( t ) = Re \{ {\sum }_{i = - \frac{{N}_{s}}{2}}^{\frac{{N}_{s}}{2} - 1} {d}_{i + {N}_{s} / 2} \cdot exp ( j 2 π ( {f}_{c} - \frac{i + 0.5}{T} ) ( t - {t}_{s} ) ) \} \\ ( {t}_{s} \leq t \leq {t}_{s} + T ) \\ s ( t ) = 0 ( t < {t}_{s} or t > {t}_{s} + T ) \qquad ( 1 )$$

The first OFDM symbol s(t) can be represented as in Equation 2 using an equivalent complex base-band expression:

$$s ( t ) = \{ {\sum }_{i - \frac{N}{2}}^{\frac{N}{2} - 1} {d}_{i + Ns / 2} \cdot exp ( j 2 π \frac{i}{T} ( t - ts ) \} \\ ( t < {t}_{s} or t > + T ) \\ s ( t ) = 0 ( t < {t}_{s} or t > {t}_{s} + T ) \qquad ( 2 )$$

In Equation 2, a real part and an imaginary part correspond to an in-phase and a quadrature phase of OFDM symbol s(t), respectively, from which a final OFDM symbol can be generated by multiplying s(t) by a cosine wave and a sine wave of proper carrier frequencies.

Referring to FIG. 1, a serial-to-parallel (S/P) transformer 100 transforms a serial input sequence into a parallel sequence and outputs the parallel sequence so as to perform IFFT on the parallel sequences.

An IFFT unit 110 transforms input QAM symbols in a single block over multiple orthogonal sub-carriers into OFDM symbols in a time domain.

A parallel-to-serial transformer (P/S) 120 transforms the parallel OFDM symbol output from the IFFT unit 110 into a serial OFDM symbol.

A cyclic prefix interleaver 130 interleaves cyclic prefixes into guard intervals of each OFDM symbol to cyclically expand the OFDM symbols so as to prevent interferences among sub-carriers. Here, the cyclic prefixes are replicas of a portion of the OFDM symbols. Also, the guard intervals are inserted into starting portions of the OFDM symbols in order to remove inter-symbol interference (ISI). The OFDM symbols with the cyclic prefixes undergo a frequency shift and then are transmitted to space via an antenna 140.

Conventional PAPR reducing techniques are adopted only in an OFDM communication system using a single antenna. In addition, there have been inadequate studies on a technique for reducing a PAPR in a multiple antenna OFDM communication system.

### DISCLOSURE OF THE INVENTION

The present invention provides a method of reducing a PAPR in a multiple antenna OFDM communication system using a space-time coding (STC) scheme.

The present invention also provides a multiple antenna OFDM communication system adopting the method of reducing a PAPR.

According to an aspect of the present invention, there is provided a method of reducing a peak-to-average-power ratio in a multiple antenna orthogonal frequency division multiplexing communication system. The method includes: reducing a peak-to-average-power ratio of input serial data sequences; space-time coding the input serial data sequences with the reduced peak-to-average-power ratio to generate N symbols to be transmitted via N antennas; receiving the serial data sequences of the N symbols to transform the serial data sequences into N parallel data sequences; allocating each of the N parallel data sequences to Nₛ sub-carriers and performing Inverse Fast Fourier Transform on the N parallel data sequences; transforming the N parallel data sequences into N serial data symbols; and replicating a portion of the serial data symbols to generate cyclic prefixes and interleaving the cyclic prefixes into starting portions of the serial data symbols to cyclically expand the N symbols.

According to another aspect of the present invention, there is provided a multiple antenna orthogonal frequency division multiplexing communication system including: a space-time coder that space-time codes input serial data sequences to generate N symbols to be transmitted via N antennas; a peak-to-average-power ratio reducer that reduces a peak-to-average-power ratio of the serial data sequences of the N symbols; a serial-to-parallel transformer that receives the serial data sequences of the N symbols with the reduced peak-to-average-power ratio to transform the serial data sequences into N parallel data sequences; an Inverse Fast Fourier Transform unit that allocates each of the N parallel data sequences to Nₛ sub-carriers and performs Inverse Fast Fourier Transform on the N parallel data sequences; a parallel-to-serial transformer that transforms the N parallel data sequences into N serial data symbols; a cyclic prefix interleaver that replicates a portion of the serial data symbols to generate cyclic prefixes and interleaves the cyclic prefixes into starting portions of the serial data symbols to cyclically expand the N symbols.

### BRIEF DESCRIPTION OF THE DRAWINGS

FIG. 1 is a block diagram of a conventional single antenna OFDM communication system.

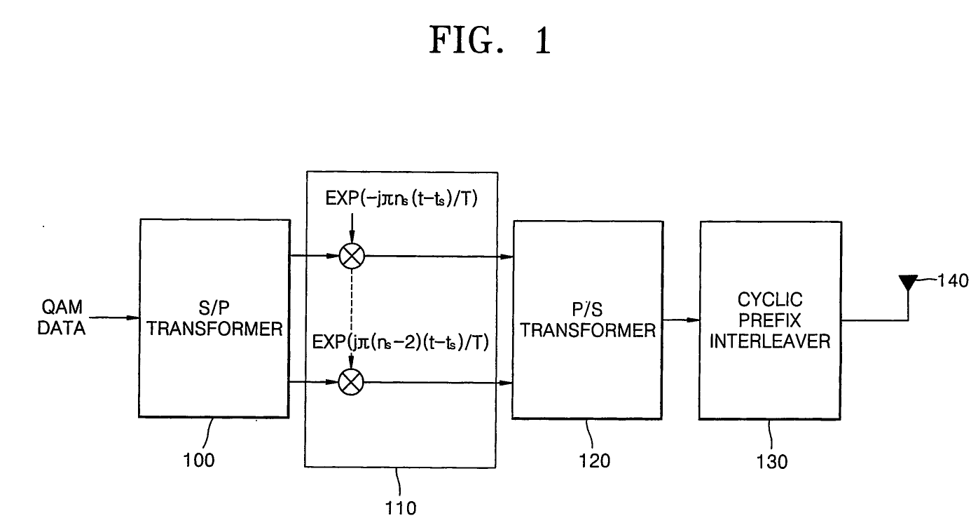

FIG. 2 is a flowchart for explaining a method of reducing a PAPR in a multiple antennal OFDM communication system, according to a preferred embodiment of the present invention.

FIG. 3 is a schematic block diagram of a multiple antenna OFDM communication system adopting the method of FIG. 2, according to a preferred embodiment of the present invention.

FIG. 4 is a schematic block diagram of a multiple antenna OFDM communication system adopting the method of FIG. 2, according to another preferred embodiment of the present invention.

### BEST MODE FOR CARRYING OUT THE INVENTION

Hereinafter, preferred embodiments of the present invention will be described in detail with reference to the attached drawings.

In order to improve transmission efficiency of a wideband OFDM system, a base station uses multiple antennas, and symbols are transmitted via the multiple antennas using a STC method.

In the present invention, any STC method used to realize Multiple-input Multiple-Output (MIMO)-based OFDM does not reduce or increase a PAPR. In other words, a PAPR in MIMO-based OFDM is between minimum and maximum PAPRs in Single-input Single-Output (SISO)-based OFDM. This can be expressed as in Equation 3:
min(PAPRₛᵢₛₒ)≦PAPRₘᵢₘₒ≦max(PAPRₛᵢₛₒ₎ (3)

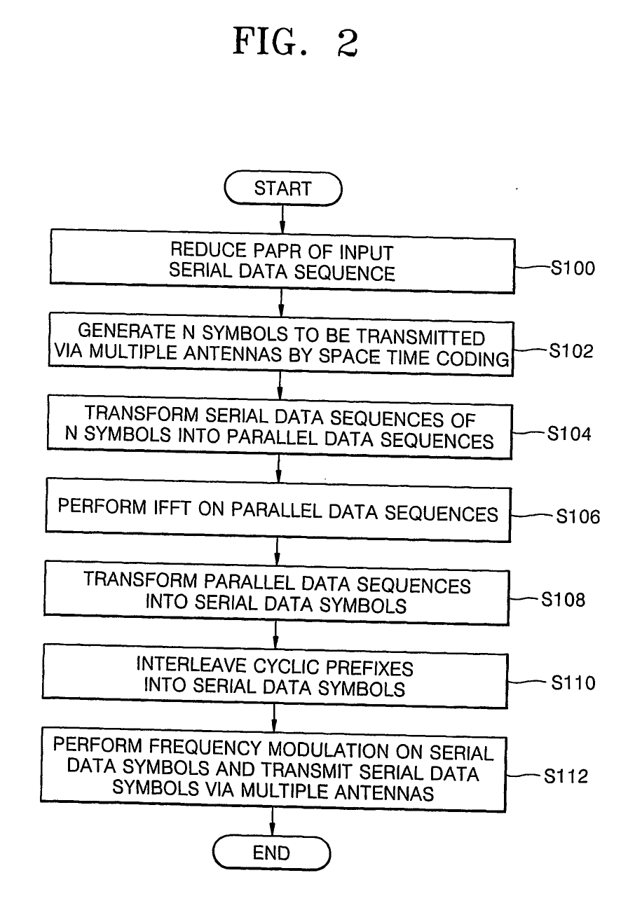

FIG. 2 is a flowchart for explaining a method of reducing a PAPR in a multiple antennal OFDM communication system, according to a preferred embodiment of the present invention. Referring to FIG. 2, the method includes: PAPR reducing step S100, STC step S102, S/P transformation step S104, IFFT step S106, P/S transformation step S108, cyclic prefix interleaving step S110, and transmission step S112.

In step S100, a PAPR of a serial input data sequence which has undergone forward error correction coding and interleaving is reduced. Here, a signal distorting scheme, a coding scheme, a scrambling scheme, or the like is used to reduce the PAPR.

The signal distorting scheme includes clipping, peak windowing, peak cancellation, and so on. Clipping is a non-linear distortion scheme which limits the peak amplitude of a signal to a specific level. In other words, clipping is the simplest way of reducing a PAPR. Peak windowing is a technique that reduces out-of-band noise resulting from clipping by multiplying a large signal peak by a non-square window. Peak cancellation is a technique that reduces the magnitude of power above a predetermined threshold.

An example of the coding scheme includes a Golay code. The coding scheme is to reduce a PAPR by using the PAPR characteristics of an OFDM signal, i.e., only a portion of the entire OFDM symbol has a high PAPR. In other words, the PAPR can be reduced using a code to generate only OFDM symbols having lower PAPRs than a desired level. The Golay code uses the characteristics of Golay complementary sequences. A pair of sequences are Golay complementary sequences if the sum of their autocorrelation functions is zero when their delayed shifts are not zero. When the Golay code is used for OFDM signal modulation, the maximum value of the PAPR is restricted to 2, i.e., 3dB, due to the characteristics of the autocorrelation functions of Golay complementary sequences. Thus, when complementary symbols are input to generate the OFDM signal, the PAPR does not exceed 3dB. The Golay complementary codes are described in detail in an article entitled “Complementary Series” by M. J. E. Golay, IRE Trans. Inform. Theory, vol. IT-7, pp.82-87, 1961. A coding scheme using Golay sequences and Reed-Muller codes is disclosed in detail in an article entitled “Peak-to-Mean Power Control and Error Correction for OFDM Transmission Using Golay Sequence and Reed-Muller Codes” by J. A. Davis and J. Jedwab, Elec. Left., vol. 33, pp. 267-268, 1997.

In the scrambling scheme, each OFDM symbol is scrambled into different scrambling sequences, and then the scrambling sequence with the lowest PAPR is selected. The scrambling scheme is to reduce the probability of a high PAPR, but does not lower the PAPR below a predetermined level.

In step 102, a signal sequence with the reduced PAPR is received and undergoes STC to generate N symbols to be transmitted via multiple antennas.

An STC method for PAPR reduction in multiple antenna OFDM will now be explained in detail.

In a single antenna, an OFDM code with a low PAPR can be detected among OFDM codes with Nₛ OFDM sub-carriers. An STC code for multiple antennas has systematic symbols and parity symbols obtained from linear combinations of the systematic symbols. The systematic symbols are independent of one another.

The judicious choice of liner dependence between the parity and systematic symbols in the component of STC assures that the PAPR of parity symbols are not enlarged. For example, an STC scheme such as delay diversity, a space-time trellis code, a space-time block code, and the like does not increase a PAPR in an OFDM communication system. The delay diversity is disclosed in detail in an article entitled “Space-Time Codes for High Data Rate Wireless Communication: Performance Analysis and Code Construction” by V. Tarokh, N. Seshadri and A. R. Calderbank, IEEE Trans. Inform. Theory, pp. 744-765, March 1998. The space-time trellis code and the space-time block code are described in detail in an article entitled “Space-Time Block Codes from Orthogonal Designs” by V. Tarokh, H. Jafarkhani and A. R. Calderbank, IEEE Trans. Inform. Theory, Vol. 45, No. 5, pp. 1456-1467, July 1999.

Various constellations may be used for the systematic symbols. In a multiple antenna OFDM communication system including Nₛ sub-carriers at a random time instant and N antennas, K space-time codes C₁, C₂, . . . , and C_{K} can be defined for the N antennas. When N constellation symbols C_{1,k,} C_{2,k,} . . . , and C_{N,k} are defined for a k^{th} OFDM symbol satisfying 1≦k≦K, K systematic symbols C_{j,1,} C_{j,2,} . . . , and C_{j,K} can be obtained for a j^{th} OFDM symbol satisfying 1≦j≦N. Accordingly, when an OFDM symbol is defined as Pⱼ, symbols P₁, P_{2,} . . . , and P_{N} can be obtained and simultaneously transmitted via the N antennas.

Examples of an OFDM code with systematic constellation symbols is include a coset of a Reed-Muller code used for 2^{m}-PSK and a 16-QAM code obtained from the Reed-Muller code. The coset of the Reed-Muller code is described in detail in an article entitled “Peak-to-Mean Power Control in OFDM, Golay Complementary Sequences, and Reed-Muller Codes” by James A. Davis, and Jonathan Jedwab, IEEE Transactions on Information Theory, Vol. 45, No. 7, pp. 2397-2417, November 1999. The 16-QAM code is disclosed in detail in an article entitled “A Construction of OFDM 16-QAM Sequences Having Low Peak Powers” by Cornelia Rossing and Vahid Tarokh, IEEE Transactions on Information Theory, Vol. 47, No. 5, pp. 2091-2094, November 2001. Here, a PAPR is limited to 3dB by the coset of the Reed-Muller code used for 2^{m}-PSK.

A Golay sequence is used to limit a PAPR of a Binary Phase Shift Keying (BPSK) signal to 3dB. The Golay sequence can be defined as a pair of Golay complementary sequences of length n which can be expressed as in Equations 4 and 5:
a=(a₀,a₁,a₂, . . . ,aₙ₋₁) (4)
b=(b₀,b₁,b₂, . . . ,bₙ₋₁) (5)

An aperiodic autocorrelation of the Golay sequence a in Equation 4 can be calculated as Ca(u) using Equation 6. An aperiodic autocorrelation of the Golay sequence b in Equation 5 can be calculated as Cb(u) by the same formula.

$$Ca ( u ) = {\sum }_{i = 0}^{n - u - 1} {a}_{i} {a}^{* i + u} dp \qquad ( 6 )$$

A pair of Golay complementary sequences are the Golay sequence if they satisfy the condition of the sum of the aperiodic autocorrelations Ca(u) and Cb(u) where powers of a pair of Golay complementary sequences become Px+Py only when u in Ca(u) is equal to u in Cb(u).

When m binary information Cᵢ is to be transmitted, the Golay sequence can be made from a Reed-Muller code xᵢ of length 2^{m} as in Equation 7:

$${\sum }_{i = 1}^{m - 1} {x}_{π ( i )} {x}_{π ( i + 1 )} + {\sum }_{i = 0}^{m} {c}_{i} {x}_{i} \qquad ( 7 )$$

wherein π denotes a permutation of {1,2, . . . ,m}. Codes with a low PAPR and a high constellation can be generated using the BPSK Golay sequence. A quadrature Phase Shift Keying (QPSK) constellation for BPSK can be given as in Equation 8:

$$QPSK = \frac{\sqrt{2}}{2} BPSK + j \frac{\sqrt{2}}{2} BPSK \qquad ( 8 )$$

An 8-QAM constellation for BPSK can be given as in Equation 9:

$$8 - QAM = \frac{\sqrt{2}}{5} BPSK + j \frac{\sqrt{2}}{5} BPSK + {ⅇ}^{- j π / 4} \sqrt{\frac{1}{5}} BPSK \qquad ( 9 )$$

A 16-QAM constellation for 8-QPSK can be given as in Equation 10:

$$16 - QAM = \frac{\sqrt{2}}{5} QPSK + j \frac{1}{\sqrt{5}} QPSK \qquad ( 10 )$$

Combining Equations 8 and 10, a 16-QAM constellation for BPSK can be given as in Equation 11:

$$16 - QAM = \sqrt{\frac{2}{5}} BPSK + j \sqrt{\frac{2}{5}} BPSK + \frac{1}{\sqrt{10}} BPSK + j \frac{1}{\sqrt{10}} BPSK \qquad ( 11 )$$

A 16-QAM constellation for QPSK of Equation 8 and 16-QAM of Equation 10 or 11 can be given as in Equation 12:

$$64 - QAM = \sqrt{\frac{16}{21}} QPSK + j \sqrt{\frac{5}{21}} 16 - QAM \qquad ( 12 )$$

Combining Equations 8, 11, and 12, a 64-QAM constellation for BPSK can be given as in Equation 13:

$$64 - QAM = \sqrt{\frac{8}{21}} BPSK + j \sqrt{\frac{8}{21}} BPSK + \sqrt{\frac{2}{21}} BPSK + j \sqrt{\frac{2}{21}} BPSK - \frac{1}{\sqrt{42}} BPSK + j \frac{1}{\sqrt{42}} BPSK \qquad ( 13 )$$

If C₁ and C₂ are BPSK codes of length n, QPSK codes for the BPSK codes C₁ and C₂ can be expressed as in Equation 14:

$${C}_{QPSK} = \frac{\sqrt{2}}{2} {C}_{1} + j \frac{\sqrt{2}}{2} {C}_{2} \qquad ( 14 )$$

If C₁, C₂, and C₃ are BPSK codes of length n, 8-QAM codes for the BPSK codes C₁, C₂, and C₃ can be expressed as in Equation 15:

$${C}_{8 - QAM} = \sqrt{\frac{2}{5}} {C}_{1} + j \sqrt{\frac{2}{5}} {C}_{2} + {ⅇ}^{- j π / 4} \sqrt{\frac{1}{5}} {C}_{3} \qquad ( 15 )$$

Accordingly, 16-QAM and 64-QAM codes can be defined from the BPSK codes.

In step S104, serial data sequences of the N symbols are received and transformed into N parallel data sequences. In other words, serial input sequences, which have undergone STC and have been modulated by PSK or QAM, are transformed into parallel sequences.

In step S106, the N parallel data sequences are allocated to the Nₛ sub-carriers, respectively, and modulated by IFFT. In other words, input PSK or QAM symbols of N parallel data are carried over multiple orthogonal sub-carriers to be transformed into parallel OFDM symbols in a time domain.

In step S108, the parallel OFDM symbols are transformed into serial OFDM symbols.

In step S110, cyclic prefixes are interleaved into the serial OFDM symbols. In other words, guard intervals are interleaved into starting portions of the OFDM symbols to remove interferences among the OFDM symbols. Next, the cyclic prefixes are interleaved into starting portions of the guard intervals to cyclically expand the OFDM symbols and prevent interference among the sub-carriers. Here, the cyclic prefixes are replicas of a portion of the OFDM signal.

In step S112, the OFDM symbols with the cyclic prefixes experience a frequency shift and then are transmitted via the N multiple antennas.

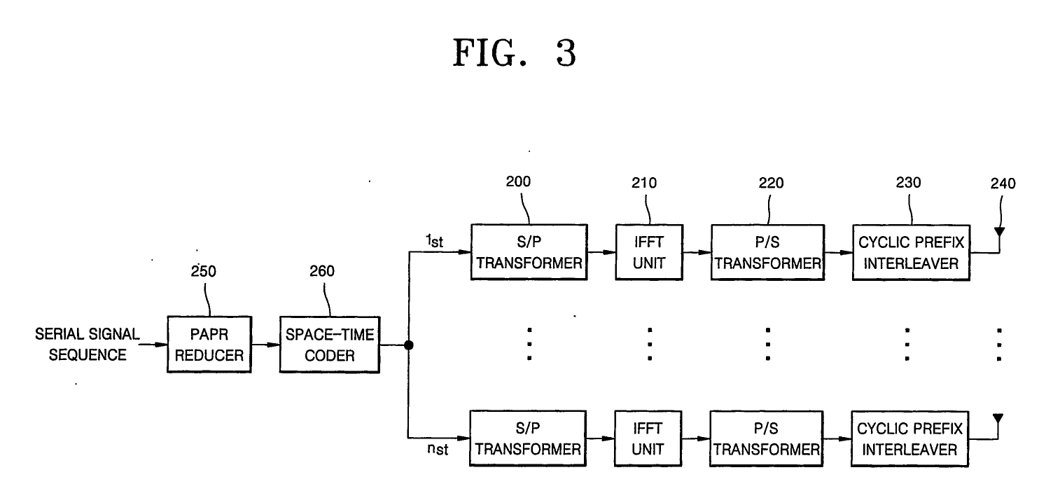

FIG. 3 is a block diagram of a multiple antenna OFDM communication system adopting the method of FIG. 2, according to a preferred embodiment of the present invention. Referring to FIG. 3, the multiple antenna OFDM communication system includes a PAPR reducer 250, a space-time coder 260, N S/P transformers 200, N IFFT units 210, N P/S transformers 220, N cyclic prefix interleavers 230, and N antennas 240.

The PAPR reducer 250 codes serial signal sequences using a Golay code or the like to reduce a PAPR. Here, the PAPR is reduced as described in step S100 of FIG. 2.

The space-time coder 260 performs STC on the serial signal sequences with the reduced PAPR into N parallel signal sequences to be transmitted via the N antennas. Here, the serial signal. sequences are coded using the STC scheme described in step S102 of FIG. 2.

The N parallel signal sequences are transmitted via the N S/P transformers 200, the N IFFT units 210, the N P/S transformers 220, the N cyclic prefix interleavers 230, and the N antennas 240.

The N S/P transformers 200 transform the N PSK or QAM serial input sequences output from the space-time coder 260 into N PSK or QAM parallel sequences.

The N IFFT units 210 transform N input QAM symbols over multiple orthogonal sub-carriers into N OFDM signals in a time domain.

The N P/S transformers 220 transform the N parallel OFDM signals output from the N IFFT units 210 into N serial OFDM signals.

The N cyclic prefix interleavers 230 interleave cyclic prefixes into guard intervals of the N OFDM signals to cyclically expand OFDM symbols in order to prevent interference among sub-carriers. Here, the cyclic prefixes are replicas of a portion of the OFDM signal, and the guard intervals are interleaved into starting portions of the OFDM symbols to remove interference among the OFDM symbols. The OFDM signals with the cyclic prefixes experience a frequency shift and then are transmitted via the N antennas 240.

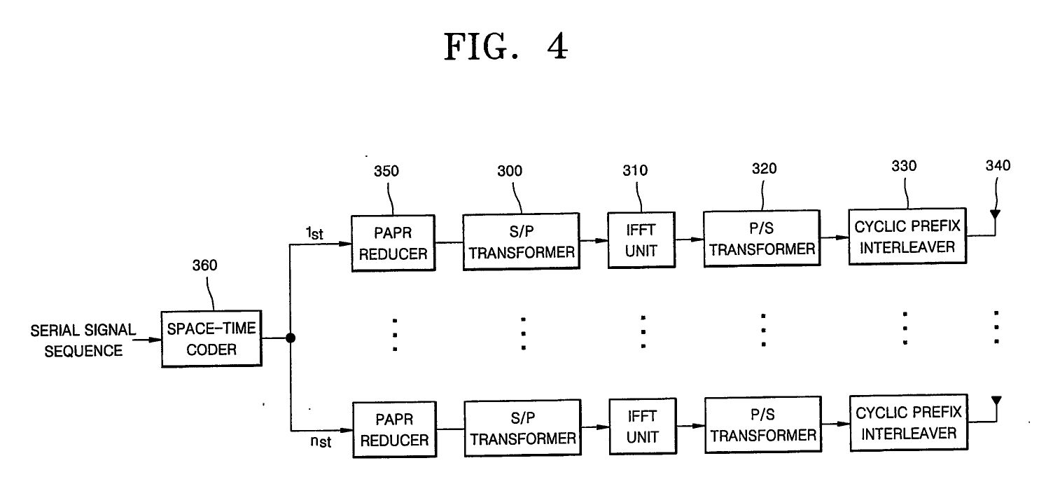

FIG. 4 is a block diagram of a multiple antenna OFDM communication system adopting the method of FIG. 2, according to another preferred embodiment of the present invention. Referring to FIG. 4, the multiple antenna OFDM communication system includes a space-time coder 360, N PAPR reducers 350, N S/P transformers 300, N IFFT units 310, N P/S transformers 320, N cyclic prefix interleavers 330, and N antennas 340.

The space-time coder 360 performs STC on a serial input signal to output N signal sequences. The N PAPR reducers 350 code the N signal sequences using a Golay code or the like to reduce PAPR. The N OFDM signal sequences output from the N PAPR reducers 350 are transmitted via the N S/P transformers 300, the N IFFT units 310, the N P/S transformers 320, the N cyclic prefix interleavers 330, and the N antennas 340.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

As described above, in a multiple antenna OFDM communication system according to the present invention, a PAPR can be efficiently reduced.

What is claimed is:

1. A method of reducing a peak-to-average-power ratio in a multiple antenna orthogonal frequency division multiplexing communication system, the method comprising:
reducing a peak-to-average-power ratio of input serial data sequences;
space-time coding the input serial data sequences with the reduced peak-to-average-power ratio to generate N symbols to be transmitted via N antennas;
receiving the serial data sequences of the N symbols to transform the serial data sequences into N parallel data sequences;
allocating each of the N parallel data sequences to Nₛ sub-carriers and performing Inverse Fast Fourier Transform on the N parallel data sequences;
transforming the N parallel data sequences into N serial data symbols; and
replicating a portion of the serial data symbols to generate cyclic prefixes and interleaving the cyclic prefixes into starting portions of the serial data symbols to cyclically expand the N symbols.

2. The method of claim 1, wherein the peak-to-average-power ratio of the input serial data sequences is reduced using a signal distorting scheme comprising clipping, peak windowing, and peak cancellation.

3. The method of claim 1, wherein the peak-to-average-power ratio of the input serial data sequences is reduced using a scrambling scheme.

4. The method of claim 1, wherein the peak-to-average-power ratio of the input serial data sequences is reduced using Golay complementary codes.

5. The method of claim 1, wherein the N symbols are generated using a 2^{m}-PSK with a low peak-to-average-power ratio and a code obtained from Equation below:
$$QPSK = \frac{\sqrt{2}}{2} BPSK + j \frac{\sqrt{2}}{2} BPSK$$

6. The method of claim 1, wherein the N symbols are generated using a 2^{m}-PSK with a low peak-to-average-power ratio and a code obtained from Equation below:
$$8 - QAM = \frac{\sqrt{2}}{5} BPSK + j \frac{\sqrt{2}}{5} BPSK + {ⅇ}^{- j π / 4} \sqrt{\frac{1}{5}} BPSK$$

7. The method of claim 5, wherein the N symbols are generated using a 2^{m}-PSK with a low peak-to-average-power ratio and a code obtained from Equation below:
$$16 - QAM = \frac{\sqrt{2}}{5} QPSK + j \frac{1}{\sqrt{5}} QPSK$$

8. The method of claim 7, wherein the N symbols are generated using a 2^{m}-PSK with a low peak-to-average-power ratio and a code obtained from Equation below:
$$64 - QAM = \sqrt{\frac{16}{21}} QPSK + j \sqrt{\frac{5}{21}} 16 - QAM$$

9. A multiple antenna orthogonal frequency division multiplexing communication system comprising:
a space-time coder that space-time codes input serial data sequences to generate N symbols to be transmitted via N antennas;
a peak-to-average-power ratio reducer that reduces a peak-to-average-power ratio of the serial data sequences of the N symbols;
a serial-to-parallel transformer that receives the serial data sequences of the N symbols with the reduced peak-to-average-power ratio to transform the serial data sequences into N parallel data sequences;
an Inverse Fast Fourier Transform unit that allocates each of the N parallel data sequences to Nₛ sub-carriers and performs Inverse Fast Fourier Transform on the N parallel data sequences;
a parallel-to-serial transformer that transforms the N parallel data sequences into N serial data symbols;
a cyclic prefix interleaver that replicates a portion of the serial data symbols to generate cyclic prefixes and interleaves the cyclic prefixes into starting portions of the serial data symbols to cyclically expand the N symbols.

10. The multiple antenna orthogonal frequency division multiplexing communication system of claim 9, wherein the peak-to-average-power ratio reducer reduces the peak-to-average-power ratio of the input serial data sequences using a signal distorting scheme comprising clipping, peak windowing, and peak cancellation.

11. The multiple antenna orthogonal frequency division multiplexing communication system of claim 9, wherein the peak-to-average-power ratio reducer reduces the peak-to-average-power ratio of the input serial data sequences using a scrambling scheme.

12. The multiple antenna orthogonal frequency division multiplexing communication system of claim 9, wherein the peak-to-average-power ratio reducer reduces the peak-to-average-power ratio of the input serial data sequences using Golay complementary codes.

13. The multiple antenna orthogonal frequency division multiplexing communication system of claim 9, wherein the space-time coder generates the N symbols using a 2^{m}-PSK with a low peak-to-average-power ratio and a code obtained from Equation below:
$$QPSK = \frac{\sqrt{2}}{2} BPSK + j \frac{\sqrt{2}}{2} BPSK$$

14. The multiple antenna orthogonal frequency division multiplexing communication system of claim 9, wherein the space-time coder generates the N symbols using a 2^{m}-PSK with a low peak-to-average-power ratio and a code obtained from Equation below:
$$8 - QAM = \frac{\sqrt{2}}{5} BPSK + j \frac{\sqrt{2}}{5} BPSK + {ⅇ}^{- j π / 4} \sqrt{\frac{1}{5}} BPSK$$

15. The multiple antenna orthogonal frequency division multiplexing communication system of claim 13, wherein the space-time coder generates the N symbols using a 2^{m}-PSK with a low peak-to-average-power ratio and a code obtained from Equation below:
$$16 - QAM = \frac{\sqrt{2}}{5} QPSK + j \frac{1}{\sqrt{5}} QPSK$$

16. The multiple antenna orthogonal frequency division multiplexing communication system of claim 15, wherein the space-time coder generates the N symbols using a 2^{m}-PSK with a low peak-to-average-power ratio and a code obtained from Equation below:
$$64 - QAM = \sqrt{\frac{16}{21}} QPSK + j \sqrt{\frac{5}{21}} 16 - QAM$$
